(19) United States
(12) Patent Application Publication
(10) Pub. No.: US 2025/0182138 A1
(43) Pub. Date: Jun. 5, 2025

(54) AUTOMATED POLICY COMPLIANCE

(71) Applicant: PAYPAL, INC., San Jose, CA (US)

(72) Inventors: Xiangrong Chen, Bazhong City (CN); Huiting Li, Shanghai (CN); Ligang Chen, Shanghai (CN); Wei Wei, Shanghai (CN); Hang Yu, Shanghai (CN); Yuguan Chen, Shanghai (CN); Wenjia Wu, Larchmont, NY (US)

(21) Appl. No.: 18/282,401

(22) PCT Filed: Jun. 2, 2023
(86) PCT No.: PCT/CN2023/098006

§ 371 Date: Sep. 15, 2023

(51) Int. Cl. G06Q 30/018; G06Q 10/0639

(52) U.S. Cl. CPC G06Q 30/018; G06Q 10/06393

(57) ABSTRACT

A system according to the present disclosure may include a processor, a centralized data warehouse, and a non-transitory computer readable medium storing thereon instructions that are executable by the processor to cause the system to perform operations. The operations may include comprising training a machine learning model based on enterprise data from the centralized data warehouse, the machine learning model trained to determine a value corresponding to a metric, receiving, from at least one external source, updated enterprise data, determining, in real-time by the machine learning model, a predicted change to the value based on the updated enterprise data, and presenting, via a graphical user interface (GUI), a suggested action based on the predicted change.

### TECHNICAL FIELD

The instant disclosure relates to managing and providing an interface incorporating real-time enterprise data analyses.

### BACKGROUND

Corporate compliance refers to the review of internal operations in order to confirm that appropriate rules and regulations are being followed. This requires the collection and maintenance of enterprise data that reflect these internal operations. As companies grow, the amount of complexity of the enterprise data grows exponentially, increasing the difficulty of review for compliance.

### BRIEF DESCRIPTION OF THE DRAWINGS

FIG. 1 is a block diagram of an example system for managing enterprise data and generating an interface.

FIG. 2 is a sequence diagram illustrating an example interface generation process involving the system of FIG. 1.

FIG. 3 is a sequence diagram illustrating an example interface generation process involving the system of FIG. 1.

FIG. 4 is a flow chart illustrating an example method of generating an interface.

FIG. 5 is a flow chart illustrating an example method of generating an interface.

FIG. 6 is a diagrammatic view of an example embodiment of a user computing environment.

### DETAILED DESCRIPTION

Generally, enterprise data are collected, stored, and maintained locally on the systems or applications that originally generated the enterprise data. For example, a roster of users with access credentials to a particular application is stored in the application itself. In order to then review the roster (e.g., for compliance), the application itself must be accessed and the roster manually retrieved. This quickly becomes an unreasonable ask as the number of applications increases. Additionally, the existence of discrete and localized enterprise data stores creates consistency issues that could impede review, as each application may store its enterprise data in a different format.

Accordingly, a system according to the disclosure herein may process enterprise data from multiple sources for storage in a centralized repository, and may retrieve and analyze these processed enterprise data for compliance and risk assessment. This processing step may involve the system normalizing data for analysis on a shared scale, as well as metadata labeling to facilitate sorting and future retrieval. By processing and storing enterprise data in this manner, the system may create a single storage location for an entire group's data, expediting future review. Additionally, by creating this shared and centralized data warehouse, the system may improve the refresh rate of enterprise data, as the system may automatically and periodically refresh each of the data sources to access updated enterprise data rather than a user having to manually refresh each source. The system, therefore, may generate a complete set of enterprise data for a group in real-time.

By leveraging this real-time dataset, the system may generate a graphical user interface (GUI) to present enterprise data to a user. Because the system has access to all relevant enterprise data, the system may be capable of a wide range of dynamic filters, such that a user can request any of a number of different types or classifications of the enterprise data, and the system may respond with a tailored GUI that includes up-to-date data. The system may also employ a machine learning (ML) model trained (e.g., using past enterprise data) to evaluate and predict compliance of a set of data, or of an action taken with respect to existing data. The system may then generate the GUI to include one or more interactive elements that prompt a user to take an action determined by the ML model to bring into or keep data in compliance. The GUI may also include options to weight different policies or risks for the system to incorporate in its compliance analysis.

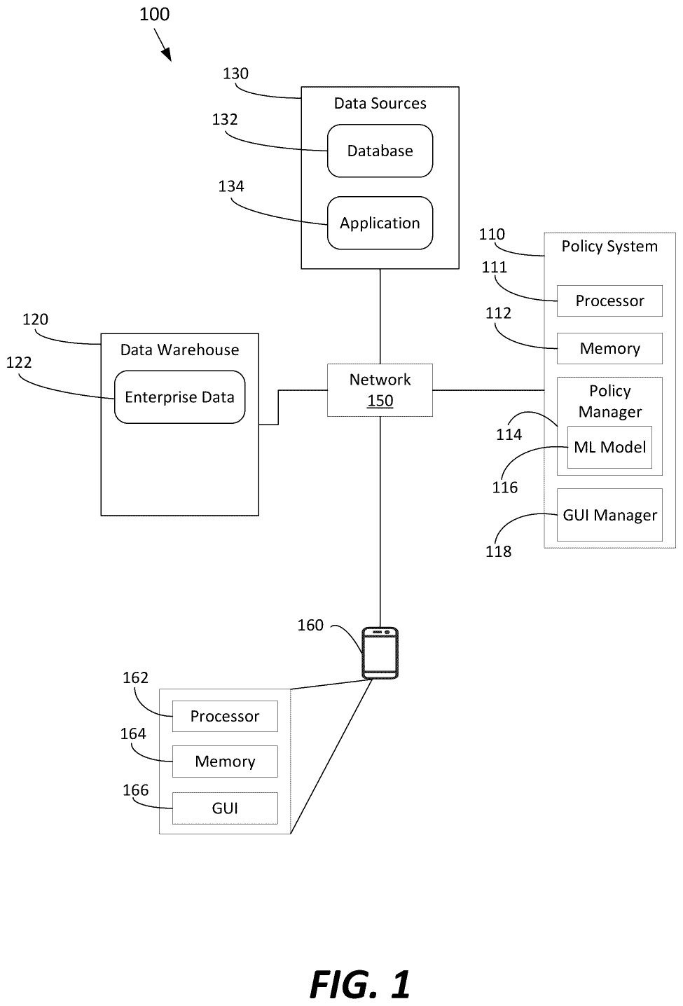

Referring to the drawings, wherein like reference numerals refer to the same or similar features in the various views, FIG. 1 is a block diagram of an example system 100 for managing enterprise data and presenting a corresponding interface. The system 100 may include a policy system 110, a data warehouse 120, data sources 130, and user computing device 160. Each of the policy system 110, the data warehouse 120, the data sources 130, and the user computing device 160 may be in electronic communication with one another and/or with other components via a network 150. The network 150 may include any suitable connection (or combinations of connections) for transmitting data to and from each of the components of the system, and may include one or more communication protocols that dictate and control the exchange of data.

As shown, the policy system 110 may include one or more functional modules 114 and 118 embodied in hardware and/or software. In an embodiment, the functional modules 114 and 118 of the policy system 110 may be embodied in a processor 111 and a memory 112 (i.e., a non-transitory, computer-readable medium) storing instructions that, when executed by the processor 111, cause the event system 110 to perform the functionality of one or more of the functional modules 114 and 118 and/or other functionality of this disclosure. For example, the policy system 110 may provide a graphical user interface (GUI) for the user device 160 that may enable the user to interact with one or more functions of policy system 110 and/or the data warehouse 120.

The data warehouse 120 may be any suitable data storage device or server configured to serve as a central repository for enterprise data 122. The enterprise data 122 may be any data that are shared by across an organization by users or members of the organization. For example, the enterprise data 122 may include a roster of members, results from security tests, or a history of interactions with a system operated by the organization. Accordingly, the enterprise data 122 may include data that are sensitive and are to be used, viewed, or otherwise handled by multiple users at the same time and across different locations, such that the data warehouse 120 may provide a secure but shared repository. The enterprise data 122 may also include compliance information, such as policies related to data management, preservation, and security.

The data sources 130 may include a database 132 and an application 134. Although reference is made throughout the disclosure to a single database 132 and a single application 134, this disclosure should not be read as limited to these embodiments, and should be read as including embodiments in which the data sources 130 include multiple databases 132 and/or multiple applications 134. The database 132 may be a separate data storage system than the data warehouse 120, such that the data stored by the database 132 may be different than and separate from the enterprise data 122. For example, the database 132 may correspond to (or be managed by) an individual user and may store data related to (or owned by) the particular user.

The application 134 may be any suitable computer- and/or mobile-based program and set of instructions that, when executed, cause the hosting device to perform a set of operations. For example, the application 134 may be a word processing program, a data management program, a web browser, etc. As part of interactions with the application 134, data may be generated (e.g., text-based documents, data spreadsheets, interaction histories, etc.) and communicated with one or more of the policy system 110, the data warehouse 120, or the user device 160.

In some embodiments, one or both of the database 132 and the application 134 may be hosted by or accessed from the user device 160. For example, the database 132 may be a cloud-based data storage platform capable of being accessed by the user device, or the database 132 may be internal storage (e.g., memory 164) of the user device 160. The application 134 may be a mobile-based application 134 saved in the memory 164 of the user device 160 and executed by the processor 162.

The functional modules 114 and 118 of the event system 110 may include a policy manager 114 configured to analyze and apply a set of compliance policies to the enterprise data 122 to determine a level of compliance. The policy manager 114 may include a machine learning (ML) model 116 trained to determine the level of compliance for a particular dataset with one or more compliance policies. In particular, the ML model 116 may be trained to estimate a level of compliance for a theoretical dataset, such that the policy manager 114 may receive an indication of a possible change to, addition to, or generation of a set of enterprise data and may, in response, output a predicted level of compliance. In some embodiments, the policy manager 114 (e.g., via the ML model 116) may determine a recommended action based on the predicted level of compliance, such as a way to bring the dataset in compliance in response to a prediction that the updated dataset would be non-compliant.

The functional modules 114 and 118 of the event system 110 may include a graphical user interface (GUI) manager 118 configured to generate and present a GUI based on output from the policy manager 114. In particular, the GUI manager 118 may present GUI 166 on the user device 160. Generating the GUI based on output from the policy manager 114 may include determining at least some of the analyzed data and/or compliance policies to display, and may include a visualization of the data and/or compliance policies. The GUI manager 118 may further incorporate the recommended action from the policy manager 114, such that the generated GUI (e.g., GUI 166) may display the recommended action, and may include an interactive element associated with the recommended action. For example, if the policy manager 114 recommends that certain data be deleted in order to bring the enterprise dataset into compliance, the GUI manager 118 may generate and present an interactive element on the GUI that, when interacted with, would cause the certain data to be deleted.

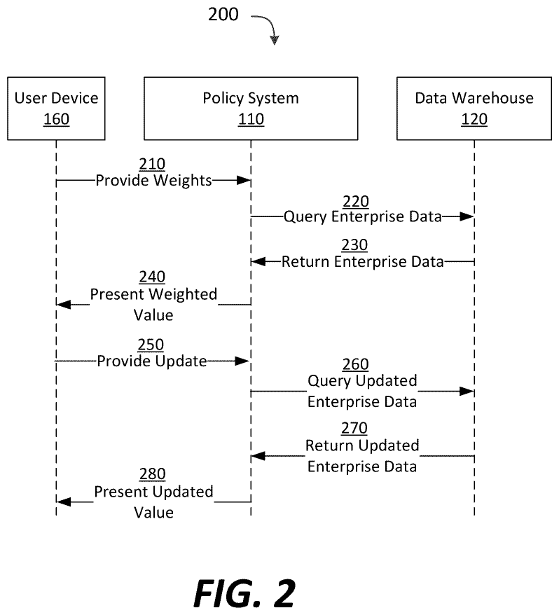

FIG. 2 is a sequence diagram illustrating an example interface generation process 200 involving the system 100 (as shown in FIG. 1). In particular, the process 200 may involve the user device 160, the policy system 110, and the data warehouse 120. The end-result of the process 200 may be generated GUI associated with a particular set of compliance policies.

As shown in FIG. 2, the process 200 may include, at operation 210, the user device 160 providing one or more weights to the policy system 110. Each weight may be associated with a particular metric or compliance policy, or with a particular risk type. For example, if the weight is associated with a particular compliance policy, a higher weight may be indicative of a relatively more important compliance policy (e.g., a government-mandated compliance policy), while a lower weight may be indicative of a relatively less important compliance policy (e.g., a focus group-suggested policy). In another example, if the weight is associated with a particular risk type, a higher weight may be indicative of a relatively more impactful risk (e.g., non-compliance could cause operational shut-down), while a lower weight may be indicative of a relatively less impactful risk (e.g., user dissatisfaction). These weights may be initially received by the user device 160 from the GUI 166.

The process 200 may include, at operation 220, the policy system 110 querying enterprise data from the data warehouse 120 and, at operation 230, the data warehouse 120 returning enterprise data to the policy system 110. The query may specify a parameter for the enterprise data, such as a particular type of enterprise data, a time range for the enterprise data, an owner of the enterprise data, etc. The policy system 110 may generate the query in response to the provided weights from the user device 160, such that the policy system 110 may specify the parameter for the query to focus on enterprise data that may correspond to policies or risks associated with higher weights. For example, if a provided weight for a compliance policy levied by the United States (US) government is relatively high, the policy system 110 may generate a query that specifies communications within the US.

In some embodiments, the data warehouse 120 may store previously-received queries and associate those stored queries with returned enterprise data. By keeping such a record, the data warehouse 120 may more quickly respond to future queries by checking a received query against the stored queries and, if there is a match, returning the enterprise data corresponding to the matched query. This may save resources, particularly for scheduled queries. For example, in generating a monthly report, the policy system 110 may generate a substantially identical query.

The process 200 may include, at operation 240, the policy system 110 presenting a weighted value to the user device 160 (e.g., by the GUI manager 118 on the GUI 166). The policy system 110 may generate the weighted value based on an analysis of the returned enterprise data in view of the provided weights. In particular, the weighted value may be indicative of a level of compliance of the returned enterprise data with the one or more policies (or risks) associated with the received weights. The policy system 110 may determine compliance, and may weight the levels of compliance with each policy (or risk) based on the provided weight. For example, if the policy system 110 determines that the returned enterprise data has a high level of compliance with a policy associated with a high weight and a low level of compliance with a policy associated with a low weight, the policy system 110 may generate a relatively high weighted value. In contrast, if the policy system 110 determines that the returned enterprise data has a high level of compliance with a policy associated with a low weight and a low level of compliance with a policy associated with a high weight, the policy system 110 may generate a relatively low weighted value.

The process 200 may include, at operation 250, the user device 160 providing an update (e.g., via the GUI 166). The update may be in response to the presentation of the weighted value at 240, such that the update may be relative to the weighted value. In particular, if the weighted value is indicative of a low level of compliance (e.g., the weighted value is relatively low), the update may be an action to address the low level of compliance. For example, the update may be deletion of data, additional encryption on data, moving of data to secure storage, etc. The update may be received via an interactive element presented on the GUI in tandem with the presentation of the weighted value at 240. For example, the policy system 110 may generate an interactive element (e.g., via the GUI manager 118) that displays a corrective or remedial action to be taken based on the weighted value. By interacting with the interactive element, a user may initiate the corrective action, which would register as an update at operation 250.

The update provided at operation 250 may include different weights (e.g., by comparison to the weights provided at operation 210), and may be based on changing circumstances (e.g., compliance with a particular policy has become more or less important) or may be to focus on a different set of or context for enterprise data.

The process 200 may include, at operation 260, the policy system 110 querying updated enterprise data based on the update provided at operation 250, and, at operation 270, the data warehouse 120 returning updated enterprise data to the policy system 110. Similarly to the query at operation 220, the updated query at operation 260 may be based on the input from the user device 160, and may specify a particular type, kind, or time frame for the enterprise data. In addition, the updated query from operation 260 may include a requested action to be performed by the data warehouse 120 (or by the policy system 110 within the data warehouse 120) for the stored enterprise data. For example, if the update provided at operation 250 includes an instruction to delete non-compliant enterprise data, the updated query may include the same instruction to be excuted by the data warehouse 120 (or by the policy system 110 within the data warehouse 120).

The process 200 may include, at operation 280, the policy system 110 presenting an updated weighted value to the user device 160. The policy system 110 may determine the updated weighted value based on the returned updated enterprise data from operation 270, as well as on the provided update from operation 250. The updated weighted value, similarly to the weighted value determined and presented by the policy system 110 at operation 240, may be indicative of a level of compliance of the updated enterprise data with one or more policies (or risks) identified in the provided weights and/or the provided update.

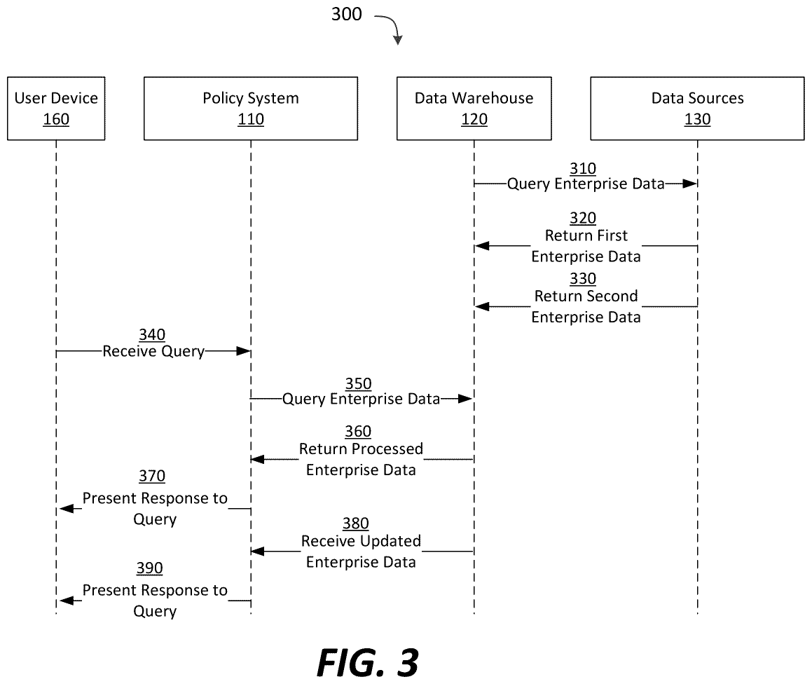

FIG. 3 is a sequence diagram illustrating an example interface generation process 300 involving the system 100 (as shown in FIG. 1). In particular, the process 300 may involve the user device 160, the policy system 110, the data warehouse 120, and data sources 130. The end-result of the process 300 may be generated GUI associated with a particular set of compliance policies that may be continuously refreshed.

As shown in FIG. 3, the process 300 may include, at operation 310, the data warehouse 120 querying enterprise data from the data sources 130. This query may be part of an initial setup for the data warehouse 120, such that the query specifies all enterprise data from the data sources 130 related to a particular field, project, department, etc. Accordingly, the data warehouse 120 may include, in the query, an indication of a type of data, a field of data, an owner of the data, and/or a timeframe for the data.

The process 300 may also include, at operation 320, the data sources 130 returning a first set of enterprise data to the data warehouse 120 and, at operation 330, returning a second set of enterprise data to the data warehouse 120. As described above with reference to FIG. 1, the data sources 130 may include a database 132 and an application 134. In these embodiments, the first enterprise data at 320 may be enterprise data from the database 132, and the second enterprise data at 330 may be enterprise data from the application 134. For example, the first enterprise data may include data related to the query and that are stored in the database 132, and the second enterprise data may include data related to the query and that are generated by the application 134. Operations 310-330 may be periodically (or continuously) repeated, such that the data warehouse 120 may request or query enterprise data from the data sources 130 at regular intervals. In this way, the process 300 may be substantially real-time, such that an output from the process 300 (e.g., the generated GUI) may be reflective of current data.

The process 300 may include, at operation 340, the policy system 110 receiving a query from the user device 160. The query may specify a type, associated department, owner, or any other parameter for enterprise data, and may be received via the GUI 166 on the user device 160. Similarly to the operation 210 of process 200, the query may also include weights. Each weight may be associated with a particular metric or compliance policy, or with a particular risk type.

At operation 350, the policy system 110 may query enterprise data from the data warehouse 120 and, at operation 360, the data warehouse 120 may return processed enterprise data based on the query. The policy system 110 may generate its query based on the query received from the user device 160. The data warehouse 120 may return enterprise data based on the query, which may specify a type of enterprise data. These enterprise data may include data received at operations 320 and 330, which the policy system 110 (and/or the data warehouse 120) may initially process in order to maintain a consistency of the enterprise data, to align the received data with previously stored data, and/or to append the received enterprise data with one or more labels (e.g., in the metadata) to facilitate responsiveness to queries. For example, if the data warehouse 120 receives enterprise data associated with a sensitive project, the data warehouse 120 may append the received data with a label indicative of the sensitivity, for which the data warehouse 120 may check prior to returning the (sensitive) enterprise data in response to an unauthorized query.

In some embodiments, the policy system 110 may directly query the data sources 130 for enterprise data, may process the received enterprise data, and may send the processed enterprise data to the data warehouse 120 for storage and future retrieval. In these embodiments, the data warehouse 120 may serve as a centralized data repository but itself may not perform any processing, such that the policy system 110 may query the data warehouse 120, and may also provide the enterprise data for retrieval.

The process may further include, at block 370, the policy system 110 presenting a response to the original query on the user device 160. The response may include a graphical representation of the enterprise data responsive to the query, such as a list or graph charting the enterprise data. In those embodiments in which the original query includes weights for one or more policies or risks, the policy system 110 may generate the weighted value based on an analysis of the returned enterprise data in view of the provided weights. In particular, the weighted value may be indicative of a level of compliance of the returned enterprise data with the one or more policies (or risks) associated with the received weights.

The process 300 may include, at operation 380, the policy system 110 receiving updated enterprise data from the data warehouse 120 and, at operation 290, presenting an updated response to the user device 160. In some embodiments, the updated enterprise data may be periodically requested by the policy system 110 from the data warehouse 120, such that the update may comprise a “pull” system initiated by the receiving party. In some embodiments, the updated enterprise data may be periodically sent by the data warehouse 120 to policy system 110, such that the update may comprise a “push” system initiated by the sending party. In both embodiments, the period for update may be a pre-determined and set value, such that the updates are pulled or pushed at set intervals of time. The period for update may also be based on a comparison to a threshold value, such that an updated set of enterprise data is pushed in response to a number of new entries (e.g., since the last update) exceeds a threshold value.

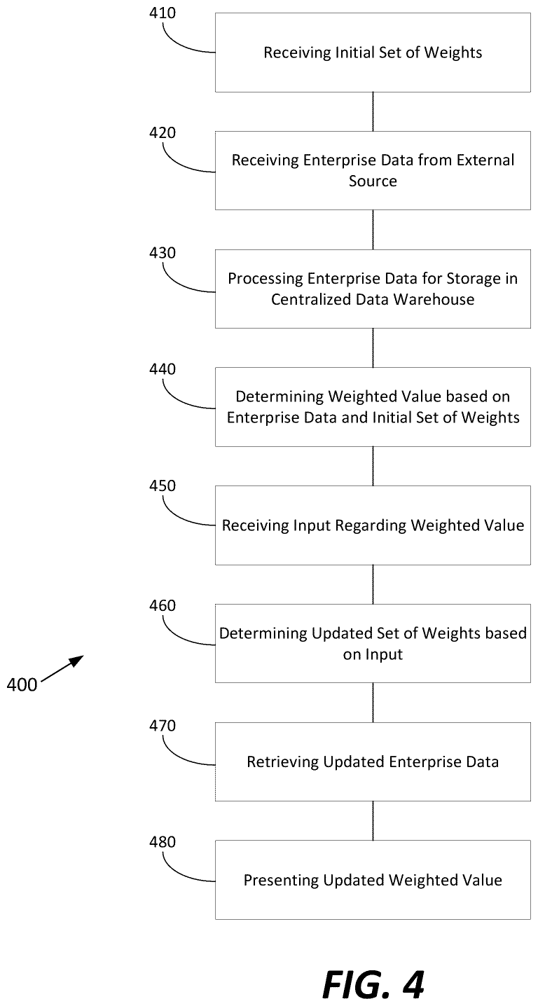

FIG. 4 is a flow chart illustrating an example method 400 of generating an interface respective of compliance with one or more policies or risks. The method 400, or one or more portions of the method 400, may be performed by system 100 and particularly the policy system 110 (shown in FIG. 1), in some embodiments.

The method 400 may include, at block 410, receiving an initial set of weights. Each weight may be associated with a particular metric or compliance policy, or with a particular risk type. For example, if the weight is associated with a particular compliance policy, a higher weight may be indicative of a relatively more important compliance policy (e.g., a government-mandated compliance policy), while a lower weight may be indicative of a relatively less important compliance policy (e.g., a focus group-suggested policy). In another example, if the weight is associated with a particular risk type, a higher weight may be indicative of a relatively more impactful risk (e.g., non-compliance could cause operational shut-down), while a lower weight may be indicative of a relatively less impactful risk (e.g., user dissatisfaction). These weights may be provided by the user device 160 (e.g., via the GUI 166) to the policy system 110.

The method 400 may also include, at block 420, receiving enterprise data from an external source and, at block 430, processing the enterprise data for storage in a centralized data warehouse. The external source (or sources) may be the data sources 130, and the policy system 110 may receive enterprise data from the data sources 130 automatically (e.g., on a “push” system) or in response to a request from the policy system 110 (e.g., on a “pull” system). The policy system 110 may process the received enterprise data in order to align a format of the received data with previously-stored data in the centralized data warehouse (e.g., data warehouse 120), to normalize data for analysis with other dissimilar data (e.g., normalizing to a value between 0 and 1), and to label or notate the received enterprise data to facilitate future requests or queries. For example, the policy system 110 may append (e.g., in the metadata of an enterprise datum) a label that a particular enterprise datum may be associated with a particular department, project, or team.

The method may include, at block 440, determining a weighted value for the enterprise data based on the initial set of weights from block 410. The policy system 110 may generate the weighted value based on an analysis of the processed enterprise data in view of the provided weights. In particular, the weighted value may be indicative of a level of compliance of the returned enterprise data with the one or more policies (or risks) associated with the received weights. The policy system 110 may determine compliance, and may weight the levels of compliance with each policy (or risk) based on the provided weight. For example, if the policy system 110 determines that the returned enterprise data has a high level of compliance with a policy associated with a high weight and a low level of compliance with a policy associated with a low weight, the policy system 110 may generate a relatively high weighted value. In contrast, if the policy system 110 determines that the returned enterprise data has a high level of compliance with a policy associated with a low weight and a low level of compliance with a policy associated with a high weight, the policy system 110 may generate a relatively low weighted value.

The method may also include, at block 450, receiving an input regarding the weighted value and, at block 460, determining an updated set of weights based on the received input. The input may be received from the user device 160 via the GUI 166, and may include an indication of a response to the weighted value, or additional requests for defining considered enterprise data. For example, the input may be a remedial action in response to a weighted value indicative of non-compliance, or the input may be for additional enterprise data to be analyzed for compliance. The policy system 110 may determine an updated set of weights based on the input. For example, if the response indicated a change in compliance policy, or a change in importance of a particular risk, the policy system 110 may quantify the indicated change as an updated weight.

The method may further include, at block 470, retrieving updated enterprise data and, at block 480, determining and presenting an updated weighted value for the updated enterprise data based on the updated set of weights. The policy system 110 may retrieve updated enterprise data based on the response when, for example, the response specifies a different set of data for analysis or a different policy for compliance.

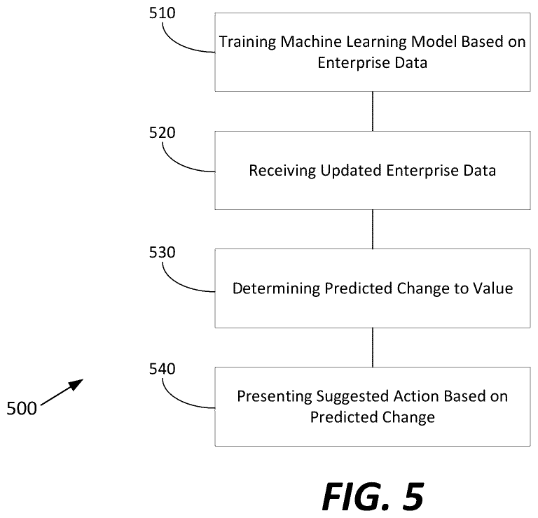

FIG. 5 is a flow chart illustrating an example method 600 of managing data lineage. The method 500, or one or more portions of the method 500, may be performed by the policy system 110 and, in particular, the policy manager 114 (shown in FIG. 1), in some embodiments.

The method 500 may include, at block 510, training a machine learning model based on enterprise data. The machine learning model may be ML model 116, and the training may be to configure the ML model 116 to receive an amount of enterprise data and to output a predicted amount of compliance and/or a probability of non-compliance with one or more policies. Accordingly, the ML model 116 may be trained with a training dataset that comprises sets of enterprise data and a known level of compliance for each set.

The method may also include, at block 520, receiving updated enterprise data and, at block 530, determining predicted change to a value based on the updated enterprise data.

The method may further include, at block 540, presenting a suggested action based on the predicted change. The suggested action may be a remedial action to avoid non-compliance (e.g., if the predicted change indicates non-compliance), or may be an action to formalize (e.g., enter) the updated enterprise data upon which the predicted change is determined.

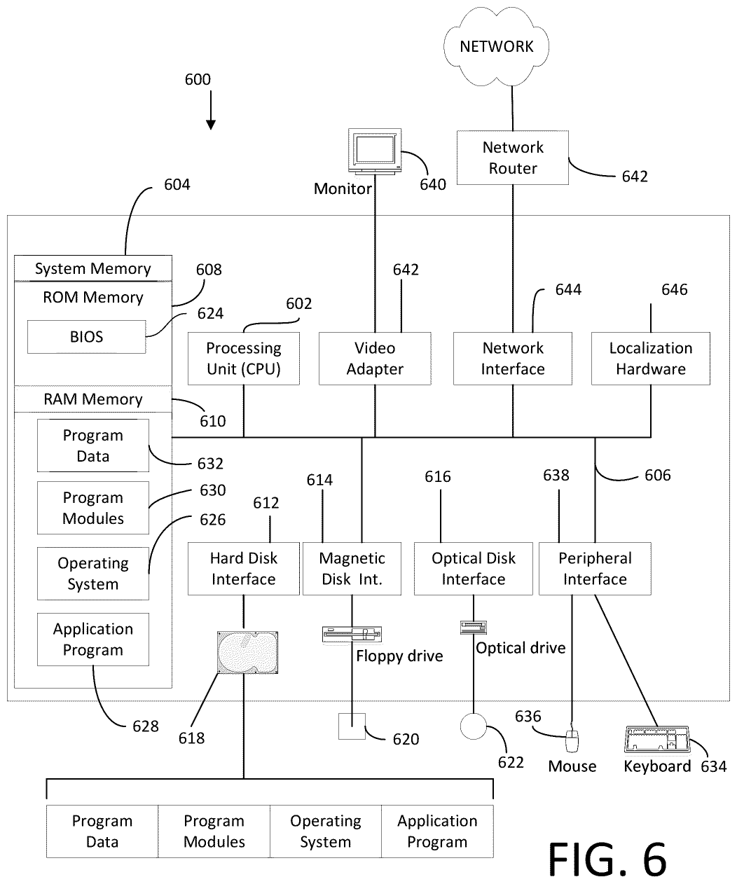

FIG. 6 is a diagrammatic view of an example embodiment of a user computing environment that includes a computing system environment 600, such as a desktop computer, laptop, smartphone, tablet, or any other such device having the ability to execute instructions, such as those stored within a non-transient, computer-readable medium. For example, the computing system environment 600 may be the user device 160 or a system hosting the policy system 110. In another example, one or more components of the computing system environment 600, such as one or more CPUs 602, RAM memory 610, network interface 644, and one or more hard disks 618 or other storage devices, such as SSD or other FLASH storage, may be included in the event system 110. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 600 typically includes at least one processing unit 602 (e.g., processor 162) and at least one memory 604 (e.g., memory 164), which may be linked via a bus. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard disk 618, and/or peripheral memory devices may be used to store computer executable instructions comprising an operating system 626, one or more applications programs 628 (which may include the functionality of the policy system 110 of FIG. 1 or one or more of its functional modules 114 and 118, for example), other program modules 630, and/or program data 632. Still further, computer-executable instructions may be downloaded to the computing environment 600 as needed, for example, via a network connection.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus via an interface, such as via video adapter 642. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 642, that is responsible for network routing. Communications with the network router 642 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 656 for determining a location of the computing system environment 600. In embodiments, the localization hardware 656 may include, for example only, a GPS antenna, an RFID chip or reader, a WiFi antenna, or other computing hardware that may be used to capture or transmit signals that may be used to determine the location of the computing system environment 600.

In some embodiments, a system includes a processor; a centralized data warehouse; and a non-transitory computer readable medium storing thereon instructions that are executable by the processor to cause the system to perform operations including training a machine learning model based on enterprise data from the centralized data warehouse, the machine learning model trained to determine a value corresponding to a metric; receiving, from at least one external source, updated enterprise data; determining, in real-time by the machine learning model, a predicted change to the value based on the updated enterprise data; and presenting, via a graphical user interface (GUI), a suggested action based on the predicted change.

In some of these embodiments, training the machine learning model includes normalizing the enterprise data; determining an effect of each datapoint of the enterprise data on the determined metric value; deriving a linear regression for the machine learning model based on the determined effects; and adjusting the linear regression according to a loss function.

In some of these embodiments, the loss function receives, as input, a predicted value from the trained machine learning model and an override value from a user.

In some of these embodiments, the at least one external source includes a relational database or a streaming application.

In some of these embodiments, the operations further include presenting, on the GUI, an interactable element; determining filtered enterprise data based on an interaction with the interactable element; determining a filtered value for the set of metrics based on the filtered enterprise data; and presenting, on the GUI, at least one of the filtered value or the filtered enterprise data.

In some of these embodiments, the operations further include continuously receiving new data from the centralized data warehouse in response to the centralized data warehouse receiving an update to the enterprise data from the external source.

In some embodiments, a computer-implemented method includes receiving, by a computing system through a graphical user interface (GUI), an initial set of weights corresponding to a set of metrics; receiving, by the computing system from a centralized data warehouse, enterprise data; determining, by the computing system, a value for each metric of the set of metrics for the enterprise data; presenting, by the computing system on the GUI, a weighted value for the set of metrics based on the initial set of weights; receiving, by the computing system through the GUI, an input regarding the weighted value; determining, by the computing system, based on the input, an updated set of weights; retrieving, by the computing system, in real-time from the centralized data warehouse, updated enterprise data; and presenting, by the computing system on the GUI, an updated value for the set of metrics based on the updated enterprise data and the updated set of weights.

In some of these embodiments, the method further includes training, by the computing system, a machine learning model based on the enterprise data; receiving, by the computing system through the GUI, a query associated with a metric of the set of metrics, the query identifying a predicted datapoint; determining, by the computing system via the machine learning model, a predicted value for the metric based on the predicted datapoint; and presenting, by the computing system, the predicted value on the GUI.

In some of these embodiments, training the machine learning model includes normalizing, by the computing system, the enterprise data; determining, by the computing system, an effect of each datapoint of the enterprise data on the weighted value; deriving, by the computing system, a linear regression for the machine learning model based on the determined effects; and adjusting, by the computing system, the linear regression according to a loss function.

In some of these embodiments, the method further includes presenting, by the computing system on the GUI, an interactable element; determining, by the computing system, filtered enterprise data based on an interaction with the interactable element; determining, by the computing system, a filtered value for the set of metrics based on the filtered enterprise data; and presenting, by the computing system on the GUI, at least one of the filtered value or the filtered enterprise data.

In some of these embodiments, the method further includes continuously receiving, by the computing system, new data from the centralized data warehouse in response to the centralized data warehouse receiving an update to the enterprise data from an external source.

In some of these embodiments, the method further includes processing, by the computing system, the update from the external source to conform with a formatting requirement of the centralized data warehouse.

In some of these embodiments, the set of metrics include a set of pre-determined polices for enterprise data.

In some embodiments, a non-transitory computer readable medium stores program instructions that, when executed by a processor, cause a computer system to perform operations including receiving, from at least one database, first enterprise data; receiving, from at least one application, second enterprise data; processing the first and second enterprise data for storage in a centralized data warehouse; in response to receipt of a query identifying a metric, determining a value for the metric based on the processed data in the centralized data warehouse; receiving, from the at least one database or the at least one application, updated enterprise data; and in real-time and in response to the updated enterprise data, updating the determined value.

In some of these embodiments, the at least one database includes at least one relational database external to the computing system, and the at least one application includes a streaming application external to the computing system.

In some of these embodiments, processing the first and second enterprise data includes altering a format of the first and second enterprise data to a format compatible with the centralized data warehouse.

In some of these embodiments, the operations further include deriving, from the processed data, a training set; training a machine learning model using the training set; receiving a query identifying a predicted datapoint; determining, by the machine learning model, a predicted value for the metric based on the predicted datapoint; and presenting the predicted value.

T In some of these embodiments, the predicted value is presented on a graphical user interface (GUI).

In some of these embodiments, training the machine learning model includes associating, for the machine learning model, a first datapoint of the training set with an actual first value for the metric, the first value included in the first datapoint; determining, by the machine learning model, a predicted second value for the metric based on a second datapoint of the training set; determining an error for the machine learning model based on a difference between the predicted second value and an actual second value from the second datapoint; and adjusting the machine learning model based on the determined error.

In some of these embodiments, the operations further include continuously refreshing the centralized data warehouse for any update to the enterprise data from the at least one database or the at least one application.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A system comprising:
a processor;
a centralized data warehouse; and
a non-transitory computer readable medium storing thereon instructions that are executable by the processor to cause the system to perform operations comprising:
training a machine learning model based on enterprise data from the centralized data warehouse, the machine learning model trained to determine a value corresponding to a metric;
receiving, from at least one external source, updated enterprise data;
determining, in real-time by the machine learning model, a predicted change to the value based on the updated enterprise data; and
presenting, via a graphical user interface (GUI), a suggested action based on the predicted change.

2. The system of claim 1, wherein training the machine learning model comprises:
normalizing the enterprise data;
determining an effect of each datapoint of the enterprise data on the determined metric value;
deriving a linear regression for the machine learning model based on the determined effects; and
adjusting the linear regression according to a loss function.

3. The system of claim 2, wherein the loss function receives, as input, a predicted value from the trained machine learning model and an override value from a user.

4. The system of claim 1, wherein the at least one external source comprises a relational database or a streaming application.

5. The system of claim 1, wherein the operations further comprise:
presenting, on the GUI, an interactable element;
determining filtered enterprise data based on an interaction with the interactable element;
determining a filtered value for the set of metrics based on the filtered enterprise data; and
presenting, on the GUI, at least one of the filtered value or the filtered enterprise data.

6. The system of claim 1, wherein the operations further comprise:
continuously receiving new data from the centralized data warehouse in response to the centralized data warehouse receiving an update to the enterprise data from the external source.

7. A computer-implemented method comprising:
receiving, by a computing system through a graphical user interface (GUI), an initial set of weights corresponding to a set of metrics;
receiving, by the computing system from a centralized data warehouse, enterprise data;
determining, by the computing system, a value for each metric of the set of metrics for the enterprise data;
presenting, by the computing system on the GUI, a weighted value for the set of metrics based on the initial set of weights;
receiving, by the computing system through the GUI, an input regarding the weighted value;
determining, by the computing system, based on the input, an updated set of weights;
retrieving, by the computing system, in real-time from the centralized data warehouse, updated enterprise data; and
presenting, by the computing system on the GUI, an updated value for the set of metrics based on the updated enterprise data and the updated set of weights.

8. The method of claim 7, further comprising:
training, by the computing system, a machine learning model based on the enterprise data;
receiving, by the computing system through the GUI, a query associated with a metric of the set of metrics, the query identifying a predicted datapoint;
determining, by the computing system via the machine learning model, a predicted value for the metric based on the predicted datapoint; and
presenting, by the computing system, the predicted value on the GUI.

9. The method of claim 7, wherein training the machine learning model comprises:
normalizing, by the computing system, the enterprise data;
determining, by the computing system, an effect of each datapoint of the enterprise data on the weighted value;
deriving, by the computing system, a linear regression for the machine learning model based on the determined effects; and
adjusting, by the computing system, the linear regression according to a loss function.

10. The method of claim 7, further comprising:
presenting, by the computing system on the GUI, an interactable element;
determining, by the computing system, filtered enterprise data based on an interaction with the interactable element;
determining, by the computing system, a filtered value for the set of metrics based on the filtered enterprise data; and
presenting, by the computing system on the GUI, at least one of the filtered value or the filtered enterprise data.

11. The method of claim 7, further comprising continuously receiving, by the computing system, new data from the centralized data warehouse in response to the centralized data warehouse receiving an update to the enterprise data from an external source.

12. The method of claim 11, further comprising processing, by the computing system, the update from the external source to conform with a formatting requirement of the centralized data warehouse.

13. The method of claim 7, wherein the set of metrics comprise a set of pre-determined polices for enterprise data.

14. A non-transitory computer readable medium storing program instructions that, when executed by a processor, cause a computer system to perform operations comprising:
receiving, from at least one database, first enterprise data;
receiving, from at least one application, second enterprise data;
processing the first and second enterprise data for storage in a centralized data warehouse;
in response to receipt of a query identifying a metric, determining a value for the metric based on the processed data in the centralized data warehouse;
receiving, from the at least one database or the at least one application, updated enterprise data; and
in real-time and in response to the updated enterprise data, updating the determined value.

15. The non-transitory computer readable medium of claim 14, wherein the at least one database comprises at least one relational database external to the computing system, and the at least one application comprises a streaming application external to the computing system.

16. The non-transitory computer readable medium of claim 14, wherein processing the first and second enterprise data comprises altering a format of the first and second enterprise data to a format compatible with the centralized data warehouse.

17. The non-transitory computer readable medium of claim 14, wherein the operations further comprise:
deriving, from the processed data, a training set;
training a machine learning model using the training set;
receiving a query identifying a predicted datapoint;
determining, by the machine learning model, a predicted value for the metric based on the predicted datapoint; and
presenting the predicted value.

18. The non-transitory computer readable medium of claim 17, wherein the predicted value is presented on a graphical user interface (GUI).

19. The non-transitory computer readable medium of claim 17, wherein training the machine learning model comprises:
associating, for the machine learning model, a first datapoint of the training set with an actual first value for the metric, the first value included in the first datapoint;
determining, by the machine learning model, a predicted second value for the metric based on a second datapoint of the training set;
determining an error for the machine learning model based on a difference between the predicted second value and an actual second value from the second datapoint; and
adjusting the machine learning model based on the determined error.

20. The non-transitory computer readable medium of claim 14, wherein the operations further comprise:
continuously refreshing the centralized data warehouse for any update to the enterprise data from the at least one database or the at least one application.
